(19) United States
(12) Patent Application Publication
(10) Pub. No.: US 2018/0041526 A1
(43) Pub. Date: Feb. 8, 2018

(54) METHOD AND APPARATUS FOR MUTUAL-AID COLLUSIVE ATTACK DETECTION IN ONLINE VOTING SYSTEMS

(71) Applicant: Nokia Technologies Oy, Espoo (FI)

(72) Inventors: Jingyu FENG, Xian (CN); Guangyue LU, Xian (CN); Honggang WANG, Xian (CN)

(21) Appl. No.: 15/552,558

(22) PCT Filed: Mar. 6, 2015
(86) PCT No.: PCT/CN2015/073777

§ 371 Date: Aug. 22, 2017

(51) Int. Cl. H04L 29/06

(52) U.S. Cl. CPC H04L 63/1416; H04L 63/1425; G07C 13/00

(57) ABSTRACT

Method and apparatus are disclosed for detecting mutual-aid collusive (MAC) attack in a voting action of an online voting system. According to some embodiments, the method comprises: calculating a consumer-voter (CV) matrix, and/or calculating a similarity (SIM) matrix; and determining MAC attackers in the voting action based at least in part on the calculated CV matrix and/or similarity matrix. The method may further comprise: extracting for each voter in the voting action, a CV vector from the CV matrix, and/or extracting for a consumer in the voting action, a CV vector from the CV matrix; judging whether there is only one CV vector having elements with a same CV value and/or whether the consumer's CV vector has elements with a same CV value; and in response to a positive judge result, determining that the voter corresponding to the only one CV vector or the consumer is a MAC attacker, and related voters corresponding to the elements with the same CV value are MAC attackers. The method may further comprise: identifying from voters in the voting action, anoles whose trust values have ever fluctuated at least once from high to low; calculating for each anole an outlier value; and determining any anole whose outlier value is larger than or equal to a detection threshold is a MAC attacker.

### FIELD OF THE INVENTION

Embodiments of the disclosure generally relate to online voting systems, and, more particularly, to mutual-aid collusive attack detection in online voting systems.

### BACKGROUND

Word-of-mouth, one of the most ancient mechanisms in the history of human society, is gaining new significance in the Internet. The online voting systems, also known as the online reputation, rating or recommending systems, are creating virtual word-of-mouth networks in which individuals share opinions and experiences on a wide range of topics.

There are many popular operational online voting systems which are referred to the services that judge the quality of items based on users' opinions. Here, items can be products, transactions, digital contents, search results, and so on. In Amazon, users give one to five stars to products. Digg is one popular website for people to discover and share content on the Internet. The cornerstone function of Digg allows users to vote a story either up or down. Citysearch.com solicits and displays user vote on restaurants, bars and performances. Additionally, online voting systems also have increasing influence on peer-to-peer (P2P) file-sharing, ad hoc routing, cooperative spectrum sensing (CSS), online social network services (SNS), and so on. The application of online voting systems in these distributed networks is shown in FIG. 1.

In a voting system, each user may play two roles, the role of voter reporting voting data and the role of consumer enjoying voting data. The primary goal of voting systems may be to determine the item quality, which may assist consumers to select high-quality items by collecting voting data from voters, and assist the system to detect low-quality items. More importantly, many applications provide services in a distributed manner, such as P2P file-sharing networks in which users can directly interact with each other. However, the online voting systems may also be centralized. That is, there are one or several central authorities (CA) collecting voting data, evaluating item quality and publishing item quality.

FIG. 2 shows the architecture of conventional online voting systems. Firstly, a consumer sends a query message to request the judgment of the item quality. Then, the CA collects the voting data from voters who know the item quality. The items may be the files in a P2P file-sharing network. If a user has downloaded a file, he/she can vote whether the quality of the file is real (‘1’) or false (‘0’). The voting system is triggered to evaluate the file quality, describing the system's judgment on whether a file is real. For voting systems, one of the most popular designs is based on majority rule. That is, the decision of item quality should agree with the majority's opinion. Specifically, for each item, let n₀ denote the number of voters who report 0 and n₁ denote the number of voters who report 1. The decision is 0 if n₀>n₁ and 1 if n₀<n₁. Finally, the CA publishes the item quality made by the system to the consumer.

However, it is possible that the majority rule may be utilized by some malicious users to manipulate the decision of the voting systems. In view of this, it would be advantageous to provide a way to allow for efficient and accurate detection of such attacks.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided a method for detecting mutual-aid collusive (MAC) attack in a voting action of an online voting system, the method comprising: calculating a consumer-voter (CV) matrix according to history voting data and history query data of the online voting system, and/or calculating a similarity (SIM) matrix according to the history voting data; and determining MAC attackers in the voting action based at least in part on the calculated CV matrix and/or SIM matrix; wherein any one element cvᵢⱼ of the CV matrix represents a number of times that a user j has reported voting data for voting actions initiated by a user i, and/or wherein any one element simᵢⱼ of the SIM matrix represents similarity between voting behaviors of the user i and the user j.

According to another aspect of the disclosure, calculating the CV matrix comprises: initializing a CV matrix to be a zero matrix; determining for a consumer of each voting action, a corresponding index i; incrementing for each voter j of the each voting action who has reported voting data, a corresponding cvᵢⱼ by one; and repeating the steps of determining and incrementing, until all voting actions in the history voting data have been processed.

According to another aspect of the disclosure, calculating the SIM matrix comprises: determining for a voter i and each remaining voter j, respective valid voting vectors Vᵢ′ and Vⱼ′ representing valid voting actions in each of which both the voter i and the voter j have reported voting data; calculating a simᵢⱼ according to similarity between the valid voting vectors Vᵢ′ and Vⱼ′; and repeating the steps of determining and calculating, until each voter i in the history voting data has been processed.

According to another aspect of the disclosure, the simᵢⱼ equals to one minus an absolute value of a difference between a ratio at which the voter i has voted “true” for valid voting actions of the both voters and a corresponding ratio of the voter j.

According to another aspect of the disclosure, determining the MAC attackers comprises: extracting for each voter in the voting action, a CV vector from the CV matrix; judging whether there is only one CV vector having elements with a same cv value; and in response to a positive judge result, determining that the voter corresponding to the only one CV vector and related voters corresponding to the elements with the same CV value are MAC attackers.

According to another aspect of the disclosure, the voter corresponding to the only one CV vector is a fixed angel, and the related voters corresponding to the elements with the same CV value are MAC attackers colluding with the fixed angel to fake voting data.

According to another aspect of the disclosure, determining the MAC attackers comprises: extracting for a consumer in the voting action, a CV vector from the CV matrix; judging whether the CV vector has elements with a same CV value; and in response to a positive judge result, determining that the consumer and related voters corresponding to the elements with the same CV value are MAC attackers.

According to another aspect of the disclosure, the consumer is a fixed angel, and the related voters corresponding to the elements with the same CV value are MAC attackers colluding with the fixed angel to prompt their trust values.

According to another aspect of the disclosure, determining the MAC attackers comprises: identifying from voters in the voting action, anoles whose trust values have ever fluctuated at least once from high to low; calculating for each anole an outlier value representing an average value of respective differences between voting behaviors of any two of the remaining anoles; and determining that any anole whose outlier value is larger than or equal to a detection threshold is a MAC attacker.

According to another aspect of the disclosure, the outlier value equals to an average value of absolute values of respective differences between a similarity value between the anole and one of the any two anoles, and a similarity value between the anole and the other of the any two anoles.

According to another aspect of the disclosure, the detection threshold is a boundary point of an outlier set consisting of all anoles' outlier values.

According to another aspect of the disclosure, the anoles whose trust values have ever fluctuated at least once below a threshold are identified from the voters in the voting action.

According to one aspect of the disclosure, it is provided an apparatus for detecting mutual-aid collusive (MAC) attack in a voting action of an online voting system, the apparatus comprising: data analysis means for calculating a consumer-voter (CV) matrix according to history voting data and history query data of the online voting system, and/or similarity measurement means for calculating a similarity (SIM) matrix according to the history voting data; and MAC detection means for determining MAC attackers in the voting action based at least in part on the calculated CV matrix and/or SIM matrix; wherein any one element cvᵢⱼ of the CV matrix represents a number of times that a user j has reported voting data for voting actions initiated by a user i, and/or wherein any one element simᵢⱼ of the SIM matrix represents similarity between voting behaviors of the user i and the user j.

According to one aspect of the disclosure, it is provided an apparatus for detecting mutual-aid collusive (MAC) attack in a voting action of an online voting system, the apparatus comprising: at least one processor; and at least one memory including computer-executable code, wherein the at least one memory and the computer-executable code are configured to, with the at least one processor, cause the apparatus to: calculate a consumer-voter (CV) matrix according to history voting data and history query data of the online voting system, and/or calculate a similarity (SIM) matrix according to the history voting data; and determine MAC attackers in the voting action based at least in part on the calculated CV matrix and/or SIM matrix; wherein any one element cvᵢⱼ of the CV matrix represents a number of times that a user j has reported voting data for voting actions initiated by a user i, and/or wherein any one element simᵢⱼ of the SIM matrix represents similarity between voting behaviors of the user i and the user j.

According to one aspect of the disclosure, it is provided a computer program product comprising at least one non-transitory computer-readable storage medium having computer-executable program code stored therein, the computer-executable code being configured to, when being executed, cause an apparatus to operate according to any one of the above described methods.

These and other objects, features and advantages of the disclosure will become apparent from the following detailed description of illustrative embodiments thereof, which are to be read in connection with the accompanying drawings.

### BRIEF DESCRIPTION OF THE DRAWINGS

FIG. 1 shows the application of online voting systems in distributed networks;

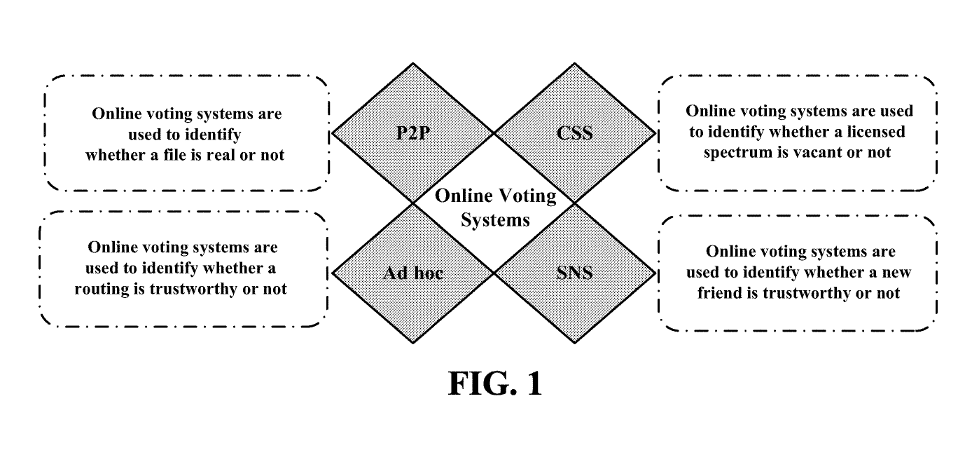

FIG. 2 shows the architecture of conventional online voting systems;

FIG. 3 shows an exemplary defense system for mutual-aid collusive (MAC) attack according to an embodiment of the present disclosure;

FIG. 4 is a flowchart showing the data analysis process according to an embodiment of the present disclosure;

FIG. 5 is a flowchart showing the similarity measurement process according to an embodiment of the present disclosure;

FIG. 6 is a flowchart showing the MAC detection process in a scenario where an angle is fixed from MAC attackers, according to an embodiment of the present disclosure;

FIG. 7 is a flowchart showing the MAC trust-prompting detection process in a scenario where an angle is fixed from MAC attackers, according to an embodiment of the present disclosure;

FIG. 8 is a flowchart showing the MAC detection process in a scenario where an angle is selected randomly from MAC attackers, according to an embodiment of the present disclosure;

FIG. 9 is a schematic view showing a general MAC attack procedure; and

FIG. 10 is a simplified block diagram showing an apparatus that are suitable for use in practicing some exemplary embodiments of the present disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Nowadays, the manipulation of voting systems is also rapidly growing. Firms post biased voting or rating data to praise their own products or bad-mouth the products of their competitors. Attackers can share files infected by viruses in P2P file-sharing networks with a high quality. Licensed spectrums can be interfered by honest users misled by trickers. Fake vote threats may mislead consumers and may hurt the businesses hosting voting systems in the long run.

This threat may be implemented by two ways: individual or collusive. Compared with collusive attack, individual attack is less harmful and can be handled. If there are a sufficient number of false voting data reported by attackers with collusive attack, the voting system would make a wrong decision for the item quality.

Fortunately, the organization of current collusive attack is incompact and less cohesive in strength, which can be suppressed by trust mechanism. In the present disclosure, the inventors hold that powering voting systems with trust mechanism is not enough, and report the discovery of mutual-aid collusive attack (MAC attack). In a MAC attack, driven by the profit that the malicious users who help other malicious users can get help from them, MAC attackers mislead the central authority (CA) through mutual aid. Once a MAC attacker gets his malicious intent by colluding with his conspirators to let the CA make a wrong decision, in return he has to fake voting data for his conspirators when they need help. If not, he will not get any help again. This new attack pattern has two characteristics.

Profit-driven: Inspired by some profits, attackers conspire with each other to form a collusive clique to falsify the voting data intentionally. For example, MAC attackers can monopolize vacant licensed spectrums in the CSS environment. They send out false sensing data together to indicate the spectrum band of a licensed spectrum is in use, although it is unused. In this case, other users make a wrong decision that the licensed spectrum is present and will not use the spectrum. Thus, a user belonging to the MAC clique can gain exclusive access to the target spectrum.

Analogously, MAC attackers can occupy routing paths in ad hoc networks, make competitors' item quality look suspicious in electronic commerce, make scammers in real life as honest in SNS, and so on.

Trust-prompting: the inventors found a quick recovery method in MAC attack. That is, one of attackers tells his/her item quality to his/her conspirers of the collusive clique in advance, and then sends a Query message to the CA. Their trust can be prompted quickly when their voting data are the same as the item quality. Such attacker who tells his/her item quality to his/her conspirers in advance is named as angel in MAC attack.

MAC attack can cause multi-dimensional damage to the performance of voting systems.

(1) With high trust, MAC attackers can damage the fairness and usability of online voting systems more easily. A high trust value means that a user's voting data can be accepted by voting systems. MAC attackers can improve their trust value easily and quickly by performing “trust-prompting”. In prior art, to promote their trust, attackers can behave honestly to the items that they are not interested in. But, this restoration effect is limited to trust.
(2) By using the power of clique strategically, MAC attackers can monopolize the resources they are interested in, and make competitors look dishonest or scammers look honest. In prior art, collusive attackers are so incompact that it is impossible to change the decision of voting systems. MAC attackers are very organized. Once one of members show his/her attack need, other MAC attackers will help him/her as soon as possible.
(3) MAC attackers can hurt the honest users' incentive to contribute voting data, since the MAC attackers' voting data have been adopted by the voting system. In prior art, the decision of voting systems are dominated by honest users, so they are happy to contribute voting data.

However, powering voting systems with trust mechanism is not enough to defeat the MAC attack. In the past, three patterns are used to launch collusive attack.

(1) An attacker can acquire multiple IDs to falsify voting data through the sybil attack. There are many techniques to defense against the Sybil attacks. Specially, if each IP is restricted to acquire an ID, this attack pattern can be addressed easily.
(2) An attacker can control multiple computers by embedding trojan viruses. This attack pattern can be suppressed by using a good antivirus software.
(3) Multiple attackers collaborate together to falsify the voting data. In this attack pattern, each attacker only has an ID. Currently, this attack pattern is used as a popular collusive attack to falsify voting data. Fortunately, the organization of this collusive attack is incompact and less cohesive in strength, which can be suppressed by trust mechanism. Various trust schemes have been proposed. They estimate whether a user is trustworthy or not, and give low weights to or even filter out the voting data from less trustworthy users when generating the final results.

In trust mechanism, one of the most popular designs is based on beta function. It first counts the number of honest and dishonest behaviors a user has conducted, and then calculates the trust value with beta function.

When a voting data (vᵢ) is given to an item Iₖ by a user Uᵢ, if vᵢ is the same as the item quality Q(Iₖ) identified by the item quality algorithm, vᵢ is considered as an honest vote. Otherwise, it is considered as a dishonest vote. For a user Uᵢ, the system calculates the number of honest voting data given by this user, denoted by honᵢ, and the number of dishonest voting data given by this user, denoted by disᵢ. The trust value of the user Uᵢ is calculated with beta function as:

$${T}_{i} = \frac{{hon}_{i} + 1}{{hon}_{i} + {dis}_{i} + 2} \qquad ( 1 )$$

However, trust mechanism may be utilized by MAC attackers. They can improve their trust value easily, since they can increase the number of honest voting data by performing “trust-prompting” several times.

The present disclosure can provide a defense scheme of mutual-aid collusive (MAC) attack (hereinafter simply referred to as DMAC). In an exemplary embodiment of the present disclosure, the DMAC scheme may comprise the following stages: at least one of a data analysis stage and a similarity measurement stage; and a MAC detection stage.

In the data analysis stage, the relationship between consumers and voters is considered from history voting data and history query data. In prior art, history voting data are used to calculate the trust value of each voter, whereas history query data are never considered. To detect MAC attackers, the inventors propose analyzing the relationship between consumers and voters.

In the similarity measurement stage, the voting similarity among voters is estimated from history voting data, which is used to confirm the relationship among MAC attackers. In prior art, history voting data are only used to calculate the trust value of each voter. On the positive side, MAC attackers have high similarity among themselves since they often attack voting systems together.

In the MAC detection stage, the relationship between consumers and voters may be considered to detect MAC attack and MAC trust-prompting in a case where an angle is fixed from MAC attackers. Alternatively or additionally, the voting similarity among voters may be considered to detect MAC attack in a case where an angle is selected randomly from MAC attackers.

In the case where MAC trust-prompting is detected, by filtering out “the number of honest voting data” provided through the detected MAC trust-prompting, MAC attackers will not get high trust value, and thus the accuracy in the calculation of trust value can be enhanced. In prior art, it is difficult to identify whether MAC attackers increase “the number of honest voting data”.

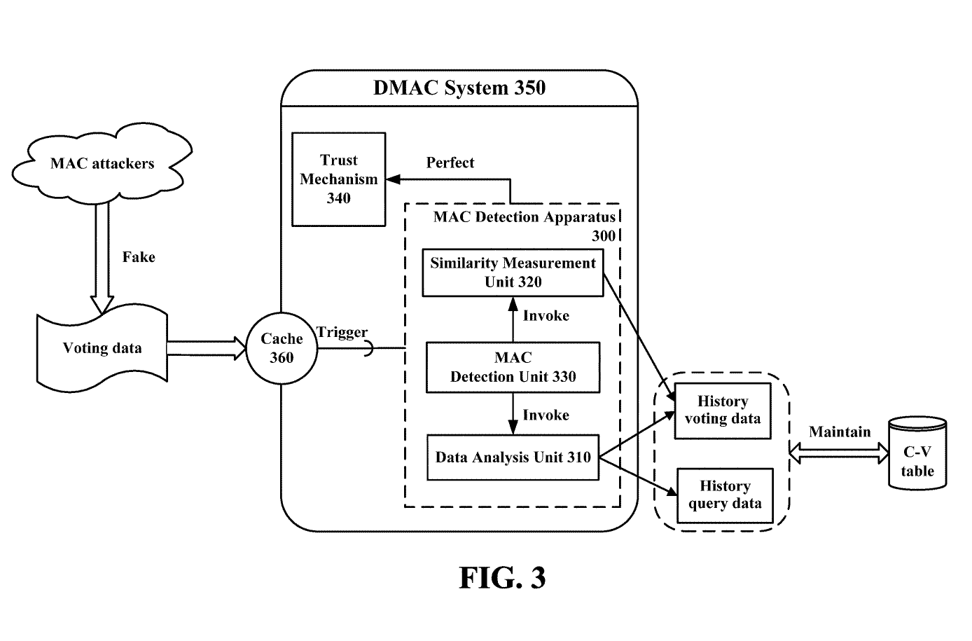

Now an exemplary embodiment of the present disclosure is described in detail with reference to FIGS. 3-10. FIG. 3 shows an exemplary defense system for mutual-aid collusive (MAC) attack (hereinafter simply referred to as DMAC system) according to an embodiment of the present disclosure. As shown, the DMAC system 350 may comprise a cache 360, a MAC detection apparatus 300 and a trust mechanism 340, wherein the MAC detection apparatus 300 may comprise a data analysis unit 310, a similarity measurement unit 320 and a MAC detection unit 330.

As mentioned earlier, MAC attackers may report fake voting data to a central authority (CA) of an online voting system. Thus, the voting data of the current voting action may contain fake voting data reported by the MAC attackers. When a decision needs to be made on the current voting action, the cache 360 may receive and store the current voting data from the CA, thereby triggering the MAC detection apparatus 300 to begin to operate.

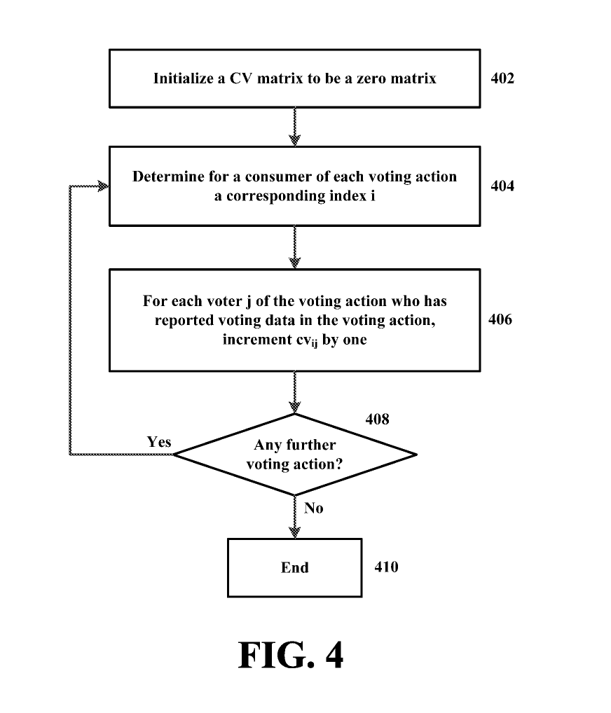

The data analysis unit 310 may calculate a consumer-voter (CV) matrix according to history voting data and history query data of the online voting system, wherein any one element cvᵢⱼ of the CV matrix represents a number of times that a user j has reported voting data for voting actions initiated by a user i. The history voting data include respective voting data reported by each voter in each voting action in the past. The history query data include respective identification information of an initiator in each voting action in the past. As an exemplary example, the history voting data and history query data may be maintained by the CA as a c-v table which will be described later. The data analysis unit 310 may be implemented by executing the data analysis process which will be described later with reference to FIG. 4.

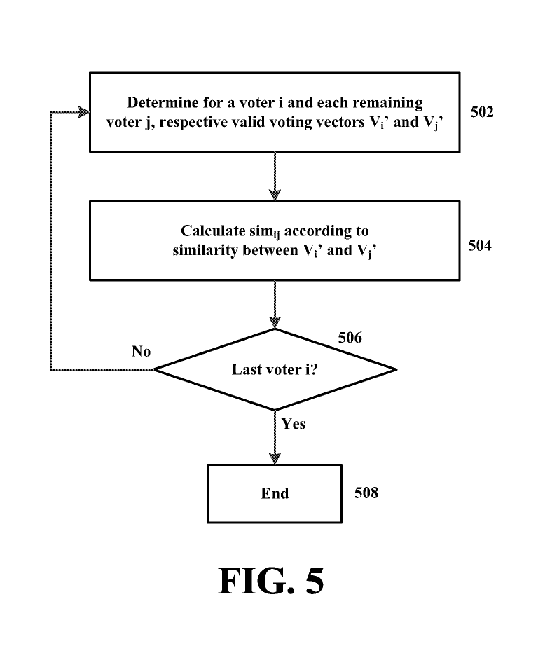

The similarity measurement unit 320 may calculate a similarity (SIM) matrix according to the history voting data, wherein any one element simᵢⱼ of the SIM matrix represents similarity between voting behaviors of the user i and the user j. The similarity measurement unit 320 may be implemented by executing the similarity measurement process which will be described later with reference to FIG. 5.

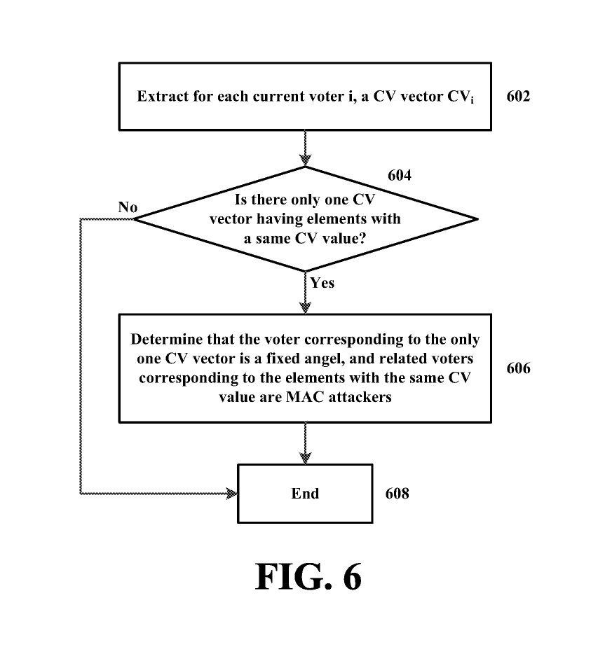

The MAC detection unit 330 may determine MAC attackers in the current voting action based at least in part on the calculated CV matrix and/or SIM matrix. The MAC attack may usually include two scenarios, i.e. a scenario where an angel is fixed from MAC attackers, and a scenario where an angel is selected randomly from MAC attackers. In the former scenario, the MAC detection unit 330 may determine the MAC attackers and detect possible trust-prompting based at least in part on the calculated CV matrix. In the latter scenario, the MAC detection unit 330 may determine the MAC attackers based at least in part on the calculated SIM matrix. The MAC detection unit 330 may also report the identification information of the detected MAC attackers and possible trust-prompting information to the trust mechanism 340. The MAC detection unit 330 may be implemented by executing the processes which will be described later with reference to FIGS. 6-8.

The trust mechanism 340 may receive the identification information of the detected MAC attackers and possible trust-prompting information from the MAC detection unit 330, and perfect the current voting data. For example, the trust mechanism 340 may filter out the voting data reported by the detected MAC attackers. In a case where possible trust-prompting is detected, during the calculation of the trust value of each voter in the current voting action, the trust mechanism 340 may filter out the voting data reported by the detected MAC attackers, such that the MAC attackers cannot recover their trust values through trust-prompting.

It should be noted that although it is shown in FIG. 3 that the MAC detection apparatus 300 comprises the data analysis unit 310, the similarity measurement unit 320 and the MAC detection unit 330, the present disclosure is not so limited. For example, the MAC detection apparatus 300 may only comprise the data analysis unit 310 and the MAC detection unit 330, which corresponds to the case where an angle is fixed from MAC attackers. For another example, the MAC detection apparatus 300 may only comprise the similarity measurement unit 320 and the MAC detection unit 330, which corresponds to the case where an angle is selected randomly from MAC attackers.

FIG. 4 is a flowchart showing the data analysis process according to an embodiment of the present disclosure. As mentioned earlier, in the data analysis process, a CV matrix may be calculated according to history voting data and history query data which may be maintained as a c-v table. An exemplary c-v table is shown in the following table 1.

TABLE 1
An exemplary c-v table

| SN | V_ID (voting data) | | | | | | C_ID |
|---|---|---|---|---|---|---|---|
| 1 | U₁ (v₁)₁ | U₂ (v₂)₁ | . . . | Uᵢ (vᵢ)₁ | . . . | Uₙ (vₙ)₁ | Uₖ₁ |
| 2 | U₁ (v₁)₂ | U₂ (v₂)₂ | . . . | Uᵢ (vᵢ)₂ | . . . | Uₙ (vₙ)₂ | Uₖ₂ |
| . . . | . . . | . . . | . . . | . . . | . . . | . . . | . . . |
| N | U₁ (v₁)_{N} | U₂ (v₂)_{N} | . . . | Uᵢ (vᵢ)_{N} | . . . | Uₙ (vₙ)_{N} | U_{kN} |

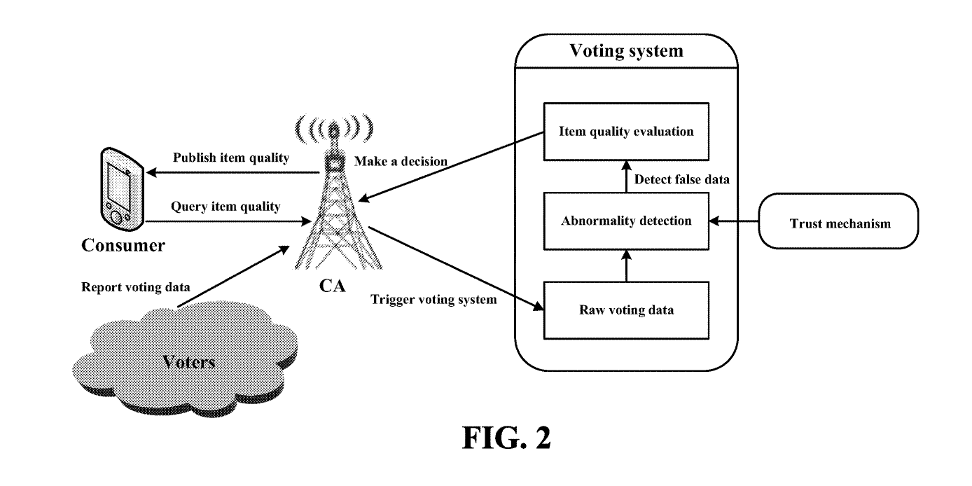

SN denotes the serial number of each voting action. It can be seen in FIG. 2 that a voting action consists of sending query, collecting voting data, evaluating item quality and publishing item quality.
V_ID (voting data) denotes the identification (ID) and voting data of each user in each voting action, where V_ID represents the ID of voter. Take Uᵢ as an example, Uᵢ(vᵢ)₂ is recorded as Uᵢ(1)₂ when Uᵢ reported good quality at the second voting action, Uᵢ(vᵢ)₂→Uᵢ(0)₂ when reported bad quality and Uᵢ(vᵢ)₂→Uᵢ(−)₂ when reported nothing.
C_ID denotes the ID of a consumer at each voting action. Since the voting data of respective voting actions was recorded in chronological order, Uₖᵢ in {Uₖᵢ, Uₖ₂, . . . , U_{kN}} may be any one element of {U₁, U₂, . . . , Uₙ}.

It should be noted that although it is shown in FIG. 3 that the history voting data and history query data is maintained as a c-v table, the present disclosure is not so limited. One skilled in the art can understand that the history voting data and history query data may be separately maintained, without being maintained together as a c-v table.

Now the details of the data analysis process will be described with reference to FIG. 4. In step 402, the process may initialize a CV matrix to be a zero matrix. Then in step 404, the process may determine for a consumer of each voting action, a corresponding index i. As mentioned above, since Uₖᵢ in {Uₖ₁, Uₖ₂, . . . , U_{kN}} may be any one element of {U₁, U₂, . . . , Uₙ} the corresponding index i may be any one element of {1, 2, . . . , n}.

Then, in step 406, for each voter j who has reported voting data in the each voting action, the process may increment the corresponding cv value cvᵢⱼ by one. Note that since the consumer of each voting action did not report voting data for this voting action initiated by himself, cvᵢᵢ equals to zero.

Then, in step 408, the process may determine whether any further voting action in the history voting data remains unprocessed. In response to a positive result in step 408, the process may proceed to step 404 such that steps 404-406 may be executed for the voting data of the further voting action. On the other hand, in response to a negative result in step 408, the process may end in step 410.

An exemplary procedure for calculating a CV matrix may be represented as follows (assuming Uᵢ is a consumer and Uⱼ is a voter).

Procedure 1 Record c-v value

Input: c-v table
Output: c-v matrix
1: Initialize each cvᵢⱼ =0
2: for each Uᵢ do
3: for each Uⱼ do
4: if (Uⱼ has reported voting data for Uᵢ) then
5: cvᵢⱼ++
6: end if
7: end for
8: end for

In this way, for all users, their c-v value compose a matrix CV_{n×n} in which the rows correspond to consumers and the columns correspond to voters.

$${CV}_{n \times n} = [ \begin{matrix}{cv}_{11} & … & {cv}_{1 n} \\ ⋮ & ⋱ & ⋮ \\ {cv}_{n 1} & … & {cv}_{nn}\end{matrix} ]$$

FIG. 5 is a flowchart showing the similarity measurement process according to an embodiment of the present disclosure. Since MAC attackers often fake voting data together, they may behave with high similarity among themselves. The similarity measurement process may be used to reveal such high similarity among MAC attackers.

In step 502, the process may determine for a voter i and each remaining voter j, respective valid voting vectors Vᵢ′ and Vⱼ′ representing valid voting actions in each of which both the voter i and the voter j have reported voting data. For example, the process may firstly extract each voter's voting data in the c-v table as a vector. Take Uᵢ as an example, his voting vector can be represented as Vᵢ=[Uᵢ(vᵢ)₁, Uᵢ(vᵢ)₂, . . . , Uᵢ(vᵢ)_{N}]. If Uᵢ(vᵢ)₁→Uᵢ(1)₁, Uᵢ(vᵢ)₂→Uᵢ(−)₂, Uᵢ(vᵢ)_{N}→Uᵢ(0)_{N}, the Vᵢ may be represented as [1, −, . . . , 0]. Then, for any two of the vectors from the C-V table, such as Uᵢ and Uⱼ, the process may eliminate the redundant data for the Vᵢ and Vⱼ. The redundant data for the Vᵢ and Vⱼ may be voting data of any voting action in which at least one of the voter i and the voter j did not report voting data. An exemplary procedure for eliminating redundancy may be represented as follows:

Procedure 2 Eliminate redundancy

Input: Vᵢ, Vⱼ
Output: Vᵢ′, Vⱼ′
1: Initialize U= Vᵢ′= Vⱼ′=Ø
2: for each Uᵢ(vᵢ)ₖ and Uⱼ(vⱼ)ₖ do
3: if ((Uᵢ(vᵢ)ₖ → Uᵢ(−)ₖ)||(Uⱼ(vⱼ)ₖ → Uⱼ(−)ₖ)) then
4: Uᵢ(vᵢ)ₖ and Uⱼ(vⱼ)ₖ are discarded simultaneously
5: else
6: Vᵢ′←{ Uᵢ(vᵢ)ₖ } which is placed to Vᵢ′ in a sequence
7: Vⱼ′←{ Uⱼ(vⱼ)ₖ } which is placed to Vⱼ′ in a sequence
8: end if
9: end for

Then, in step 504, the process may calculate for the voter i and the each remaining voter j, a similarity value simᵢⱼ according to similarity between the Vᵢ′ and Vⱼ′. For example, the similarity value simᵢⱼ may be defined as one minus an absolute value of a difference between a ratio that at which the voter i has voted “true” for valid voting actions of the both voters and a corresponding ratio of the voter j, that is:

$${sim}_{ij} = 1 - \vert \frac{{‖ 1 ‖}_{i}^{′}}{‖ {V}_{i}^{′} ‖} - \frac{{‖ 1 ‖}_{j}^{′}}{‖ {V}_{j}^{′} ‖} \vert , \qquad ( 2 )$$

where ∥1∥ᵢ′ denotes the amount of “1” in Vᵢ′, ∥1∥ⱼ′ denotes the amount of “1” in Vⱼ′, ∥Vᵢ′∥ denotes the amount of elements in the Vᵢ′, and ∥Vⱼ′∥ denotes the amount of elements in the Vⱼ′. Note that the similarity value simᵢⱼ may also be defined as:

$${sim}_{ij} = 1 - \vert \frac{{‖ 0 ‖}_{i}^{′}}{‖ {V}_{i}^{′} ‖} - \frac{{‖ 0 ‖}_{j}^{′}}{‖ {V}_{j}^{′} ‖} \vert . \qquad ( 3 )$$

The proof is as follows:

$$\vert \frac{{‖ 0 ‖}_{i}^{′}}{‖ {V}_{i}^{′} ‖} - \frac{{‖ 0 ‖}_{j}^{′}}{‖ {V}_{j}^{′} ‖} \vert = \vert \frac{‖ {V}_{i}^{′} ‖ - {‖ 1 ‖}_{i}^{′}}{‖ {V}_{i}^{′} ‖} - \frac{‖ {V}_{j}^{′} ‖ - {‖ 1 ‖}_{j}^{′}}{‖ {V}_{j}^{′} ‖} \vert = \vert 1 - \frac{{‖ 1 ‖}_{i}^{′}}{‖ {V}_{i}^{′} ‖} - 1 + \frac{{‖ 1 ‖}_{j}^{′}}{‖ {V}_{j}^{′} ‖} \vert = \vert \frac{{‖ 1 ‖}_{i}^{′}}{‖ {V}_{i}^{′} ‖} - \frac{{‖ 1 ‖}_{j}^{′}}{‖ {V}_{j}^{′} ‖} \vert .$$

It should be noted that the present disclosure is not so limited, and any other definition for simᵢⱼ may be set according to the similarity between the Vᵢ′ and Vⱼ′. For example, the similarity value simᵢⱼ may also be defined as a ratio at which both the voter i and the voter j reported a same voting data for valid voting actions of the both voters.

It should also be noted that in step 504, when a simᵢⱼ has been calculated, this calculated simᵢⱼ may be assigned to simⱼᵢ, since simᵢⱼ equals to simⱼᵢ.

Then, in step 506, the process may determine whether the current voter i is the last voter in the history voting data. In response to a negative result in step 506, the process may proceed to step 502 such that steps 502-504 are repeated for the next voter. On the other hand, in response to a positive result in step 506, the process may end in step 508. In this way, for all voters, their voting vectors compose a matrix

$${SIM}_{n \times n} = [ \begin{matrix}{sim}_{11} & … & {sim}_{1 n} \\ ⋮ & ⋱ & ⋮ \\ {sim}_{n 1} & … & {sim}_{nn}\end{matrix} ]$$

FIG. 6 is a flowchart showing the MAC detection process in a scenario where an angle is fixed from MAC attackers, according to an embodiment of the present disclosure. In this scenario, since the angle is fixed, the other MAC attackers may have the same c-v value related to the angel.

In step 602, the process may extract for each voter in the current voting action, a CV vector from the CV matrix. For example, for a voter i in the current voting action, a CV vector of the i-th row may be extracted from the CV matrix.

Then, in step 604, the process may determine for respective CV vectors of all voters in the current voting action, whether there is only one CV vector having elements with a same CV value. In response a positive result in step 604, the process may determine that the voter corresponding to the only one CV vector is a fixed angel, and related voters corresponding to the elements with the same CV value are MAC attackers. On the other hand, in response to a negative result in step 604, the process may end in step 608.

An exemplary procedure for the above MAC detection may be represented as follows, where C denotes the set of current voters and M denotes the set of MAC attackers.

Procedure 3 Detect MAC attackers (scenario 1)

Input: CV_{n×n}, C, k
Output: M

| | |
|---|---|
| 1: | Initialize M=Ø, k=0 |
| 2: | for each Uᵢ∈C do |
| 3: | CVᵢ = [cvᵢ₁, cvᵢ₂,..., cvᵢⱼ..., cvᵢₙ] from the ith row of CV_{n×n}, CVᵢ′=Ø |
| 4: | if (CVᵢ has the element with same c-v value ) then |
| 5: | CVᵢ may be a fixed angel |
| 6: | k++ |
| 7: | end if |
| 8: | end for |
| 9: | if (k==1) then |
| 10: | CVᵢ is a fixed angel |
| 11: | Extract the elements with the same c-v value from CVᵢ to CVᵢ′ |
| 12: | for each Uⱼ ∈C do |
| 13: | if (cvᵢⱼ∈CVᵢ′) then |
| 14: | M←{ Uⱼ } which is placed to M |
| 15: | end if |
| 16: | end for |
| 17: | end if |

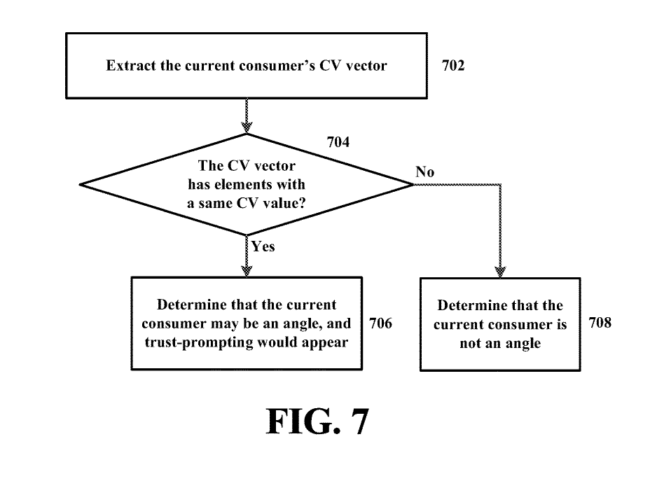

FIG. 7 is a flowchart showing the MAC trust-prompting detection process in a scenario where an angle is fixed from MAC attackers, according to an embodiment of the present disclosure. In step 702, the process may extract the current consumer's CV vector from the CV matrix. For example, if the current consumer's index is i, a CV vector of the i-th row may be extracted from the CV matrix.

Then, in step 704, the process may determine whether the extracted CV vector has elements with a same CV value. In response to a positive result in step 704, the process may determine that the current consumer may be an angle, and trust-prompting would appear. On the other hand, in response to a negative result in step 704, the process may determine that the current consumer is not an angle.

An exemplary procedure for the above MAC detection may be represented as follows, where Uᵢ is assumed to be the consumer who sent a query message to request the current voting action.

Procedure 4 Identify “trust-prompting”

Input: CVᵢ, C
Output: y
1: Initialize CVᵢ =[cvᵢ₁, cvᵢ₂,..., cvᵢⱼ..., cvᵢₙ]
2: if (CVᵢ has the element with same c-v value ) then
3: CVᵢ may be an angel and “trust-prompting” would appear
4: y=1
5: else
6: CVᵢ is not an angel
7: y=0
8: end if

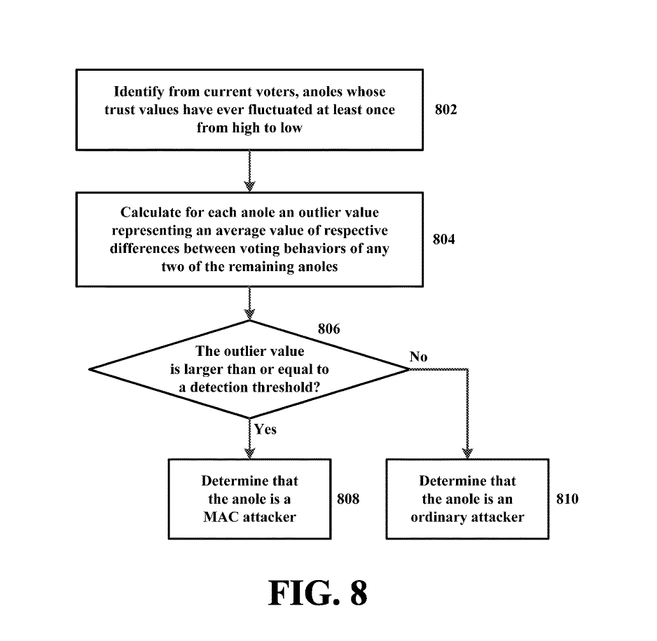

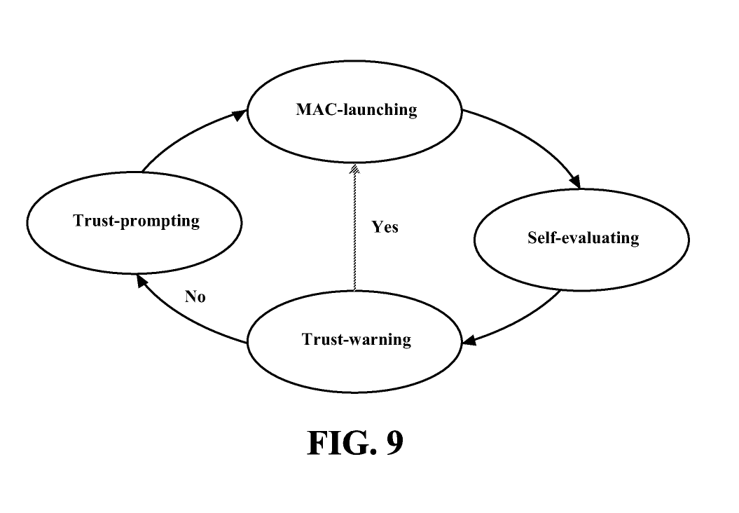

FIG. 8 is a flowchart showing the MAC detection process in a scenario where an angle is selected randomly from MAC attackers, according to an embodiment of the present disclosure. For better understanding of the MAC detection process in this scenario, the MAC attack procedure will be described at first with reference to FIG. 9.

As shown, the MAC attack procedure is generally conducted in a round mode. In the MAC-launching phase, MAC attackers collude with each other to fake voting data. Further, in the self-evaluating phase, each MAC attacker Uₖ calculates his trust value tₖ after launching the MAC attack, and broadcasts it to his conspirators.

Further, in the trust-warning phase, each Uₖ checks whether ∥ε≦tₖ<ε+λ∥≦m/2, where m is the number of the MAC attackers, ε is the threshold of trust value, λ is the trust warning line of MAC attackers, and ∥ε≦tₖ<ε+λ∥ denotes the number of MAC attackers under the case ε≦tₖ<ε+λ. As each tₖ∈[0,1], ε is usually set to a moderate value, such as 0.5. For tₖ≧ε, Uₖ will be not identified by trust mechanism since he is marked as honest. This inspires MAC attackers to find a way to prompt their trust. To maintain the attack strength better, they should begin to improve their trust value when ∥ε≦tₖ<ε+λ∥≧m/2. This is because it is too late to improve trust when tₖ<ε. In this case, Uₖ will be marked as malicious by trust mechanism and anyone won't trust him again. Here, λ (0≦λ<1−ε) is the trust warning line of MAC attackers. It may be not necessary to set the trust warning line in a larger value. Otherwise, MAC attackers will be busy improving trust even if a small reduction in their trust values appears.

Thus, as mentioned above, if the above check result in the trust-warning phase is yes, Uₖ continues the “MAC-launching” phase, and if the check result is no, Uₖ goes to the “trust-prompting” phase. In the “trust-prompting” phase, a quick recovery to trust is employed by MAC attackers. That is, one of attackers tells his item quality to his conspirers of the collusive clique in advance, and then sends a query message to the CA. Their trust can be prompted quickly when their voting data are the same as the item quality. This phase continues until ∥tₖ≧ε+λ∥=m. Such attacker who tells his item quality to his conspirers in advance is named as angel in MAC attack.

It can be seen that although the angle is selected randomly, MAC attackers' trust values fluctuate from high to low due to “trust-prompting” and “MAC-launching”. Thus, in step 802, the process may identify from the voters of the current voting action, anoles whose trust values have ever fluctuated at least once from high to low. For example, the history trust value data of all users may be calculated by using the trust mechanism (e.g., the trust mechanism 340 shown in FIG. 3) and saved in the CA. The process may query the history trust value data of each current voter from the CA, and determine whether the current voter's trust values have fluctuated at least once from high to low. As an exemplary example, the process may determine whether the current voter's trust values have ever fluctuated below a threshold. As mentioned above, a MAC attacker Uₖ usually goes to the trust-prompting phase when his trust value tₖ satisfies ε≦tₖ<ε+λ. Thus, as an exemplary example, the threshold may be set to ε+λ. However, the present disclosure should not be so limited, and the threshold may also be set to be any other appropriate values depending on the specific conditions of the application environment.

Then, in step 804, the process may calculate for each anole an outlier value representing an average value of respective differences between voting behaviors of any two of the remaining anoles. For example, the outlier value may be calculated as an average value of absolute values of respective differences between a similarity value between the anole and one of the any two remaining anoles, and a similarity value between the anole and the other of the any two remaining anoles. That is, assuming h is the number of the identified anoles, the process may extract SIM_{h×h} from the SIM matrix SIM_{n×n}. Assuming Uᵢ is an anole identified in the current voting action and SIMᵢ=[simᵢ₁, sim₂, . . . , simᵢⱼ . . . , simᵢₕ]. The outlier value of Uᵢ may be calculated as:

$${o}_{i} = \frac{1}{{C}_{h - 1}^{2}} \sum \vert {sim}_{ij} - {sim}_{ik} \vert , \qquad ( 4 )$$

where Cₕ₋₁² denotes the number of 2-combinations of (h−1), and j and k are any two numbers which are selected from the set obtained by removing i from {1, 2, . . . , h} and satisfy j>k.

It should be noted that the present disclosure is not so limited, and any other definition of the outlier value may be set according to the average value of respective differences between voting behaviors of any two of the remaining anoles. For example, the outlier value oᵢ may also be calculated as:

$${o}_{i} = \frac{1}{{C}_{h - 1}^{2}} \sum \vert 1 - {sim}_{jk} \vert . \qquad ( 5 )$$

Then, in step 806, the process may determine the outlier value of each anole is larger than or equal to a detection threshold. For example, the detection threshold may be assigned adaptively in each voting action. Specifically, δ may be calculated as the boundary point of the outlier set (O). To get the boundary point, O is sorted from largest to smallest. For the sorted O, the difference among outlier values is very small before the boundary point. For example, b equals to 0.82 in [0.91, 0.88, 0.86, 0.82, 032, 0.25].

Then, in response to a positive result in step 806, the process may determine that the anole is a MAC attacker. On the other hand, in response to a negative result of step 806, the process may determine that the anole is an ordinary attacker who may behave honestly sometimes. In this way, by means of the similarity among the identified anoles, the ordinary attackers may be filtered out from the identified anoles.

An exemplary procedure for the above MAC detection may be represented as follows, where δ is the detection threshold of outlier value and A is the set of anoles.

Procedure 5 Detect MAC attackers (scenario 2)

Input: A
Output: M
1: Initialize M=Ø
2: for each Uᵢ ∈A do
3: if (oᵢ≧δ) then
4: M←{Uᵢ} which is placed to M
5: else
6: Uᵢ is an attacker who behaved honestly sometimes
7: end if
8: end for

Based on the above description, the following advantageous technical effects can be achieved in the present disclosure:

(1) It can not only suppress MAC attack for online voting systems effectively, but also identify attackers who behaved honestly sometimes.
(2) Trust-prompting can be identified from MAC attackers.
(3) By filtering out “the number of honest voting data” achieved through trust-prompting, the accuracy in the calculation of trust value can be enhanced.
(4) It can ensure the fairness and usability of online voting systems with the isolation of MAC attackers.

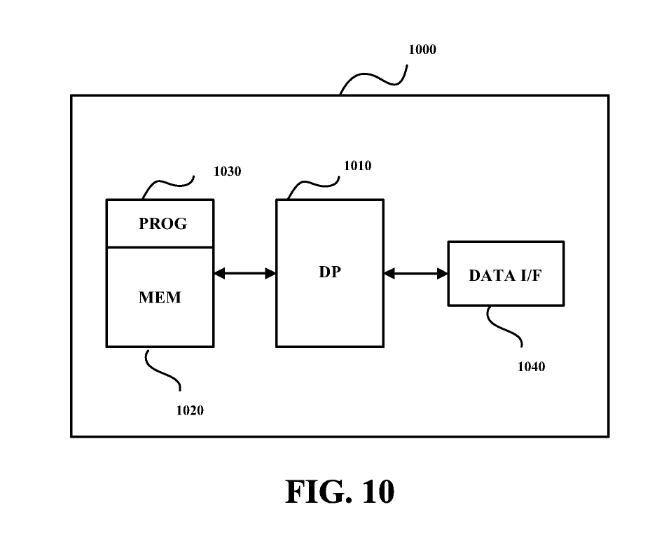

FIG. 10 is a simplified block diagram showing an apparatus that are suitable for use in practicing some exemplary embodiments of the present disclosure. For example, the MAC detection apparatus 300 shown in FIG. 3 may be implemented through the apparatus 1000. As shown, the apparatus 1000 may include a data processor (DP) 1010, a memory (MEM) 1020 that stores a program (PROG) 1030, and a data interface 1040 for exchanging data with other external devices through wired communication, wireless communication, a data bus, and so on.

The PROG 1030 is assumed to include program instructions that, when executed by the DP 1010, enable the apparatus 1000 to operate in accordance with the exemplary embodiments of this disclosure, as discussed above. That is, the exemplary embodiments of this disclosure may be implemented at least in part by computer software executable by the DP 1010, or by hardware, or by a combination of software and hardware.

The MEM 1020 may be of any type suitable to the local technical environment and may be implemented using any suitable data storage technology, such as semiconductor based memory devices, flash memory, magnetic memory devices and systems, optical memory devices and systems, fixed memory and removable memory. The DP 1010 may be of any type suitable to the local technical environment, and may include one or more of general purpose computers, special purpose computers, microprocessors, digital signal processors (DSPs) and processors based on multi-core processor architectures, as non-limiting examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random-access memory (RAM), etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1-37. (canceled)

38. A method for detecting mutual-aid collusive (MAC) attack in a voting action of an online voting system, the method comprising:
calculating a consumer-voter (CV) matrix according to history voting data and history query data of the online voting system, and/or calculating a similarity (SIM) matrix according to the history voting data; and
determining MAC attackers in the voting action based at least in part on the calculated CV matrix and/or SIM matrix;
wherein any one element cvᵢⱼ of the CV matrix represents a number of times that a user j has reported voting data for voting actions initiated by a user i, and/or wherein any one element simᵢⱼ of the SIM matrix represents similarity between voting behaviors of the user i and the user j.

39. The method according to claim 38, wherein calculating the SIM matrix comprises:
determining for a voter i and each remaining voter j, respective valid voting vectors Vᵢ′ and Vⱼ′ representing valid voting actions in each of which both the voter i and the voter j have reported voting data;
calculating a simᵢⱼ according to similarity between the valid voting vectors Vᵢ′ and Vⱼ′; and
repeating the steps of determining and calculating, until each voter i in the history voting data has been processed.

40. The method according to claim 39, wherein the simᵢⱼ equals to one minus an absolute value of a difference between a ratio at which the voter i has voted “true” for valid voting actions of the both voters and a corresponding ratio of the voter j.

41. The method according to claim 38, wherein determining the MAC attackers comprises:
extracting for each voter in the voting action, a CV vector from the CV matrix;
judging whether there is only one CV vector having elements with a same cv value; and
in response to a positive judge result, determining that the voter corresponding to the only one CV vector and related voters corresponding to the elements with the same CV value are MAC attackers.

42. The method according to claim 41, wherein the voter corresponding to the only one CV vector is a fixed angel, and the related voters corresponding to the elements with the same CV value are MAC attackers colluding with the fixed angel to fake voting data.

43. The method according to claim 38, wherein determining the MAC attackers comprises:
extracting for a consumer in the voting action, a CV vector from the CV matrix;
judging whether the CV vector has elements with a same CV value; and
in response to a positive judge result, determining that the consumer and related voters corresponding to the elements with the same CV value are MAC attackers.

44. The method according to claim 43, wherein the consumer is a fixed angel, and the related voters corresponding to the elements with the same CV value are MAC attackers colluding with the fixed angel to prompt their trust values.

45. An apparatus for detecting mutual-aid collusive (MAC) attack in a voting action of an online voting system, the apparatus comprising:
at least one processor; and
at least one memory including computer-executable code,
wherein the at least one memory and the computer-executable code are configured to, with the at least one processor, cause the apparatus to:
calculate a consumer-voter (CV) matrix according to history voting data and history query data of the online voting system, and/or calculate a similarity (SIM) matrix according to the history voting data; and
determine MAC attackers in the voting action based at least in part on the calculated CV matrix and/or SIM matrix;
wherein any one element cvᵢⱼ of the CV matrix represents a number of times that a user j has reported voting data for voting actions initiated by a user i, and/or wherein any one element simᵢⱼ of the SIM matrix represents similarity between voting behaviors of the user i and the user j.

46. The apparatus according to claim 45, wherein the computer-executable code are further configured to, when executed by the at least one processor, cause the apparatus to:
initialize a CV matrix to be a zero matrix;
determine for a consumer of each voting action, a corresponding index i;
increment for each voter j of the each voting action who has reported voting data, a corresponding cvᵢⱼ by one; and
repeat the steps of determining and incrementing, until all voting actions in the history voting data have been processed.

47. The apparatus according to claim 45, wherein the computer-executable code are further configured to, when executed by the at least one processor, cause the apparatus to:
determine for a voter i and each remaining voter j, respective valid voting vectors Vᵢ′ and Vⱼ′ representing valid voting actions in each of which both the voter i and the voter j have reported voting data;
calculate a simᵢⱼ according to similarity between the valid voting vectors Vᵢ′ and Vⱼ′; and
repeat the steps of determining and calculating, until each voter i in the history voting data has been processed.

48. The apparatus according to claim 47, wherein the simᵢⱼ equals to one minus an absolute value of a difference between a ratio at which the voter i has voted “true” for valid voting actions of the both voters and a corresponding ratio of the voter j.

49. The apparatus according to claim 45, wherein the computer-executable code are further configured to, when executed by the at least one processor, cause the apparatus to:
extract for each voter in the voting action, a CV vector from the CV matrix;
judge whether there is only one CV vector having elements with a same cv value; and
in response to a positive judge result, determine that the voter corresponding to the only one CV vector and related voters corresponding to the elements with the same CV value are MAC attackers.

50. The apparatus according to claim 49, wherein the voter corresponding to the only one CV vector is a fixed angel, and the related voters corresponding to the elements with the same CV value are MAC attackers colluding with the fixed angel to fake voting data.

51. The apparatus according to claim 45, wherein the computer-executable code are further configured to, when executed by the at least one processor, cause the apparatus to:
extract for a consumer in the voting action, a CV vector from the CV matrix;
judge whether the CV vector has elements with a same CV value; and
in response to a positive judge result, determine that the consumer and related voters corresponding to the elements with the same CV value are MAC attackers.

52. The apparatus according to claim 51, wherein the consumer is a fixed angel, and the related voters corresponding to the elements with the same CV value are MAC attackers colluding with the fixed angel to prompt their trust values.

53. The apparatus according to claim 45, wherein the computer-executable code are further configured to, when executed by the at least one processor, cause the apparatus to:
identify from voters in the voting action, anoles whose trust values have ever fluctuated at least once from high to low;
calculate for each anole an outlier value representing an average value of respective differences between voting behaviors of any two of the remaining anoles; and
determine that any anole whose outlier value is larger than or equal to a detection threshold is a MAC attacker.

54. The apparatus according to claim 53, wherein the outlier value equals to an average value of absolute values of respective differences between a similarity value between the anole and one of the any two anoles, and a similarity value between the anole and the other of the any two anoles.

55. The apparatus according to claim 53, wherein the detection threshold is a boundary point of an outlier set consisting of all anoles' outlier values.

56. The apparatus according to claim 53, wherein the anoles whose trust values have ever fluctuated at least once below a threshold are identified from the voters in the voting action.

57. A computer program product comprising at least one non-transitory computer-readable storage medium having computer-executable program instructions stored therein, the computer-executable instructions being configured to, when being executed, cause an apparatus to operate according to claim 38.
